(19) United States
(12) Patent Application Publication
(10) Pub. No.: US 2006/0046739 A1
(43) Pub. Date: Mar. 2, 2006

(54) Method and apparatus for improving performance in wireless networks by tuning receiver sensitivity thresholds

(75) Inventors: John Blosco, Coventry, OH (US); David Petsko, Richfield, OH (US)

Correspondence Address: TUCKER, ELLIS & WEST LLP, 1150 HUNTINGTON BUILDING, 925 EUCLID AVENUE, CLEVELAND, OH, 44115-1475, US

(73) Assignee: Cisco Technology, Inc.

(21) Appl. No.: 11/187,305

(22) Filed: Jul. 22, 2005

Related U.S. Application Data
(63) Continuation-in-part of application No. 10/977,284, filed on Oct. 29, 2004.
(60) Provisional application No. 60/604,269, filed on Aug. 25, 2004.

(51) Int. Cl. H04Q 7/20

(52) U.S. Cl. 455/453

(57) ABSTRACT

A method to adjust either the detection sensitivity threshold (e.g., the clear channel assessment (CCA) for an 802.11 complaint wireless transceiver) and/or the receiver communication sensitivity threshold (e.g., the start of packet (SOP) for an 802.11 complaint wireless transceiver) to improve performance in a wireless networking environment, such as a high density environment. Both the detection cell and the communication cell can be set equal to each other or the detection cell and communication cell can be independently set. There are also described herein techniques for determining detection cell. Also described herein are techniques for determining communication cell. The present invention includes apparatuses configured to implement a method and/or technique described herein.

### CROSS-REFERENCE TO RELATED APPLICATIONS

This application is a continuation-in-part of U.S. application Ser. No. 10/977,284, filed on Oct. 29, 2004, which claims the benefit of priority of U.S. Provisional Application No. 60/604,269 filed Aug. 25, 2004, all of which are hereby incorporated herein by reference.

### BACKGROUND OF THE INVENTION

The present invention relates generally to wireless networks and to techniques for adjustment of one or more receiver sensing thresholds in wireless devices. Specifically, the invention relates to techniques for adjustment of a receiver communication (packet demodulation) sensitivity threshold and/or a receiver detection (packet recognition) sensitivity threshold in wireless devices operating in wireless networks including cellular types such as IEEE 802.11 WLAN's.

An ordinary, wireless network (system) may be comprised of a wired distribution system (DS), one or more wired-to-wireless medium (WM) access points (AP's), and usually one or many wireless stations (STA's). Examples of wireless stations are portable PC's (laptops), portable digital assistants (PDA's), wireless phones or any other wireless device having basic wireless service capability. In an infrastructure type wireless network, wireless stations are associated to a single AP that facilitates the network access and data transport between the wireless stations and wired distribution system (DS). An example of the wired distribution system may be an Ethernet network. A non-infrastructure type wireless network, usually called ad-hoc or peer-to-peer wireless network is generally comprised of wireless stations (STA's) that may take on a temporal AP or wireless relay functionality role.

In order for a wireless station to join or associate to an AP, the wireless station must be within the communications range of that AP. The communications range of any wireless device (e.g., AP or STA) is related substantially to the minimal limit of the receiver dynamic range (e.g., sensitivity), regardless of the type of physical limit mechanism (e.g., SNR limit, RSS Threshold limit, etc.). Specifically, this minimal communication sensitivity limit may be a receiver Start of Packet (SOP) Threshold.

In addition to the communications range, a wireless device also has a signal detection range. The signal detection range of a wireless device (AP or STA) is related substantially to the minimal limit of the receiver dynamic range, regardless of the type of physical limit mechanism (e.g., SNR limit, RSS Threshold limit, etc). Specifically, this minimal detection sensitivity limit may be the receiver Clear Channel Assessment (CCA) Threshold.

In any wireless device (AP or STA), the minimal communications range may be substantially different from the minimal detection range (re: receiver dynamic range). Moreover, the minimal detection range is usually greater or equal to the communications range consistent with the least complex communication signaling that may be received under normal circumstances (e.g., communication cell for the lowest available data rate, shortest packet length, etc.).

As described herein, the communications range of a wireless device may be equally described as a communications cell (coverage area) having a communications radius indicating separation or distance. Also, the detection range of a wireless device may be equally described as a detection cell (area) having a detection radius indicating separation or distance. For each range (communication and detection), a wireless device has a tuning adjustment capability or threshold corresponding to each. The AP cell, AP range, or physical cell always corresponds to the physical coverage area the AP is designated to provide wireless access (detection and communications) to STA's.

As described in U.S. patent application Ser. No. 10/977,284 and U.S. Provisional Application No. 60/604,269, raising the receiver communication sensitivity threshold (SOP) and/or receiver detection sensitivity threshold (CCA) can be advantageously applied to wireless networks, especially contention based network access types such as IEEE 802.11 WLAN's. For example, raising the SOP threshold can improve network efficiency by reducing receiver busy times processing irrelevant signals that essentially capture the receiver. An improved method for reducing unnecessary receiver capture is one which optimally discriminates against excessive SOP sensitivity based on signaling criteria such as interference range, received power level, or received data rate. A simple direct threshold adjustment may also be employed (fixed tuning method). Likewise, raising the CCA threshold can improve network efficiency by reducing unnecessary transmitter hold-offs between AP's and/or STA's due to RF channel contention. An improved method for controlling or managing transmitter hold-offs is one which automatically discriminates against insufficient or excessive CCA sensitivity based signaling criteria such as received signal type (desired or undesired), range, power level, or data rate. A simple direct threshold adjustment may also be employed (fixed tuning method).

A High Density (HD) wireless network generally refers to the concept or capability of effectively increasing the density of access points (cell) within a given coverage area over what would be considered normal in practice. Specifically, High Density is used to describe an infrastructure based management technique or techniques employed by AP's and STA's for adjustment of receiver communication cell (SOP) and detection cell (CCA) thresholds for the purpose of optimizing (increasing) the available network capacity. It is well known that wireless networks having a limited number of available RF channel frequency's and employing contention based media access methods (e.g., CSMA/CA) experience a network capacity scaling deficiency with instances of substantial (local) RF frequency reuse.

The Hidden Node phenomenon occurs if one or more other STA's operating in an AP cell cannot reliably detect the presence of another STA (the ‘hidden node’) causing a breakdown of the CSMA/CA protocol. Specifically, if a particular STA operating within an AP cell transmits and one or more other STA's operating in the same AP cell cannot reliably detect that transmission, that particular STA is considered a hidden node. The Hidden Node phenomenon is undesirable in a wireless cellular type networks due to the probability of intra-cellular interference that may result.

FIGS. 1a and 1b, are examples illustrating the Hidden Node Phenomenon. FIGS. 1a and 1b represent a conceptual example of the communications range and detection range of an ordinary cellular type of wireless network cell, such as an IEEE 802.11 WLAN type. In FIGS. 1a and 1b, consider that STA1 and STA2 are each associated and members of AP1 cell 10. In FIG. 1a, the communication cells 12, 14 of STA1 STA2 respectively and AP1 10 are shown. In FIG. 1b, the detection cells 13, 15 of STA1 and STA2 respectively, and AP1 11 are shown. In FIG. 1b, the detection cells of STA1 and STA2 are insufficient to detect the presence of communications between STA1 or STA2 and AP1. Therefore, if either STA1 or STA2 transmits to AP1, the other STA can not reliably detect the transmission and may simultaneously transmit resulting in an interference probability in which one or both signals transmitted may be lost.

In a typical wireless networks including cellular types such as IEEE 802.11 WLAN networks, channel access protocols may be used (e.g., RTS/CTS) to mitigate unknown interference problems such as hidden nodes, usually at an acceptable bandwidth overhead cost. In some applications, though, the channel access protocol (overhead) burden may not be advantageous, especially when short transmission periods are included (e.g., voice protocol). For such applications, additional channel access protocol significantly reduces overall network efficiency (capacity).

The Exposed Node phenomenon occurs if an AP or STA operating in a given cell can be detected by an AP or STA operating in another cell, usually on the same RF channel frequency. For example, an STA is considered exposed if an AP or STA's operating in a given cell can be detected by an AP or STA operating in another cell, usually on the same RF channel frequency. Specifically, if a particular STA operating within a given cell transmits and one or more STA's operating in another separate cell can detect that transmission and holds-off transmission as a result of the detection, the transmitting STA is considered an exposed node. Although CSMA/CA mechanism is intended to also mitigate interference occurrences related to intercellular detection of signals (any co-channel AP cells), in some circumstances the mechanism is too sensitive and may result in unnecessary transmission holds-offs.

FIGS. 2a and 2b, illustrate examples of the Exposed Node phenomenon. FIGS. 2a and 2b represent a conceptual example of the communication range and detection range of RF cells operating in an ordinary cellular type of wireless network, such as two RF co-channel cells operating in an IEEE 802.11 WLAN. In FIGS. 2a and 2b, consider that STA1,2 are associated and members of AP1,2 cells 21, 22 respectively. In FIG. 2a, the communication cells of STA1 23, STA2 24 and AP1 21 and AP2 22 are shown. In FIG. 2b, the detection cells of STA1 26, STA2 27 and AP1 25 and AP2 28 are shown. Comparison of FIGS. 2a and 2b show the detection cells 26, 27 of STA1, STA2 are larger than the communication cells 25, 28 of AP1, AP2 cells, respectively. Therefore, STA's (or AP's) operating in AP cells may hold-off transmission for intercellular co-channel interference traffic (e.g., STA1 holds-off transmission for detection of STA2 transmission). In some instances, the transmission hold-off is due to excessive detection sensitivity and results in reduced networking efficiency (capacity).

Another consequence of the Exposed Node phenomenon is related to the AP or STA receiver communications range and specifically the receiver (signal) capture mechanism including the communication sensitivity threshold (SOP). As shown in FIG. 2a, although STA1,2 are associated and members of AP1,2, respectively, the communications range(s) of each wireless device commonly extend into neighboring AP coverage areas (adjacent or co-channel cells). The neighboring wireless devices (AP's or STA's) may therefore be considered (correlated or uncorrelated) signal interference sources. Neighbor signal interference is typically received by wireless devices unintentionally and is captured (locked/decoded at least partly) by the receiving device resulting in the wireless device being busy (cannot receive intended signals).

FIG. 3 illustrates an example 300 of various ranges associated with a high density wireless network. There are four cell ranges illustrated in FIG. 3a, the physical cell size 30, the communication cell 31 of AP1 (which is actually larger than physical cell size 30), communication cell 32 of STA1 and communication cell 33 of STA2.

The physical cell size 30 is the cell size that is planned for when a cellular system is set up. This cell is setup to account for frequency re-use of cellular systems and is used for the planned area in which a Glet wireless station is assumed to be associated to a particular AP.

FIG. 3b illustrates an example of detection cells for a AP cell. The detection cell is the range in which a station will defer transmission or hold off for another signal source based on physical or virtual hold off mechanisms. The other source can be another 802.11 device if CS (carrier sense) detection is used, or RSSI. AP1 has a physical cell size 30, and a detection cell 35 that is larger than the physical cell size 30. The detection cells 36, 37 are for wireless stations STA1, STA2 respectively.

### BRIEF SUMMARY OF THE INVENTION

In accordance with an aspect of the present invention, there is described herein a method or methods for adjustment of a receiver communication (packet demodulation) sensitivity threshold and/or a receiver detection (packet recognition) sensitivity threshold in wireless devices (AP's or STA's) operating in cellular wireless networks, including, but not limited to High Density IEEE 802.11 WLAN's to achieve a desired range.

In accordance with an aspect of the present invention, there is described herein a method for operating a wireless station (STA) comprising setting one of the group consisting of a communication sensitivity threshold and a detection sensitivity threshold relative to the access point (AP) communication sensitivity threshold and detection sensitivity threshold settings, such as the planned cell radius. It is contemplated that the AP communication sensitivity threshold and detection sensitivity threshold are adjusted to correspond to a predetermined physical AP cell coverage area (e.g., AP cell plan). It is further contemplated the STA is associated to the AP and therefore a member of the AP cell in which the detection sensitivity and communication sensitivity threshold adjustments are referred.

In accordance with another aspect of the present invention there is described herein a wireless station (STA) comprising a wireless transceiver and a controller coupled to the wireless transceiver and operative to control the operation of the wireless transceiver. The controller is configured for setting one of the group consisting of a STA communication sensitivity threshold and a detection sensitivity threshold corresponding conceptually to a prescribed AP coverage area (AP cell plan).

Still other aspects of the present invention will become readily apparent to those skilled in this art from the following description wherein there is shown and described a preferred embodiment of this invention, simply by way of illustration of one of the best modes best suited for to carry out the invention. As it will be realized, the invention is capable of other different embodiments and its several details are capable of modifications in various obvious aspects all without departing from the invention. Accordingly, the drawing and descriptions will be regarded as illustrative in nature and not as restrictive.

### BRIEF DESCRIPTION OF THE SEVERAL VIEWS OF THE DRAWING

The accompanying drawings incorporated in and forming a part of the specification, illustrate several aspects of the present invention, and together with the description serve to explain the principles of the invention.

FIG. 1 is a diagram illustrating an example of the hidden node phenomenon of a wireless local area network.

FIG. 2 is a diagram illustrating an example of the exposed node phenomenon of a wireless local area network.

FIG. 3 is a diagram illustrating communication and detection ranges associated with a physical cell range plan in a wireless network.

FIG. 4 is a diagram illustrating a technique for adjusting the detection range statistically to abate hidden nodes.

FIG. 5 is a diagram illustrating a technique for adjusting the detection range dynamically to abate hidden nodes.

FIG. 6 is a diagram illustrating a technique for adjusting the detection range dynamically based on the physical separation of the farthest node from the access point.

FIG. 7 is a diagram illustrating a technique for adjusting the communication range statically to abate the exposed node problem.

FIG. 8 is a diagram illustrating a technique for adjusting the communication range dynamically to abate the exposed node problem.

FIG. 9 is a diagram illustrating independently adjusting both the detection range and the communication range.

FIG. 10 is a histogram for determining a threshold setting for the detection sensitivity and/or the communication sensitivity.

FIG. 11 is a diagram illustrating multiple access points sharing the same channel.

FIG. 12 is a block diagram of a wireless station.

FIG. 13 is a block diagram of a computer system suitably adapted for adjusting the detection cell and/or the communication cell.

FIG. 14 is a block diagram of a method for setting detection cell and/or communication cell.

FIG. 15 is a block diagram of a method for setting detection cell.

FIG. 16 is a block diagram of a method for setting communication range.

FIG. 17 is a block diagram of a method using a histogram for setting detection range and/or communication range.

FIG. 18 is a diagram illustrating a technique for adjusting the detection range based on receiving a clear to send signal from an associated access point.

FIG. 19 is a block diagram of a method for adjusting detection range based on receiving a clear to send signal.

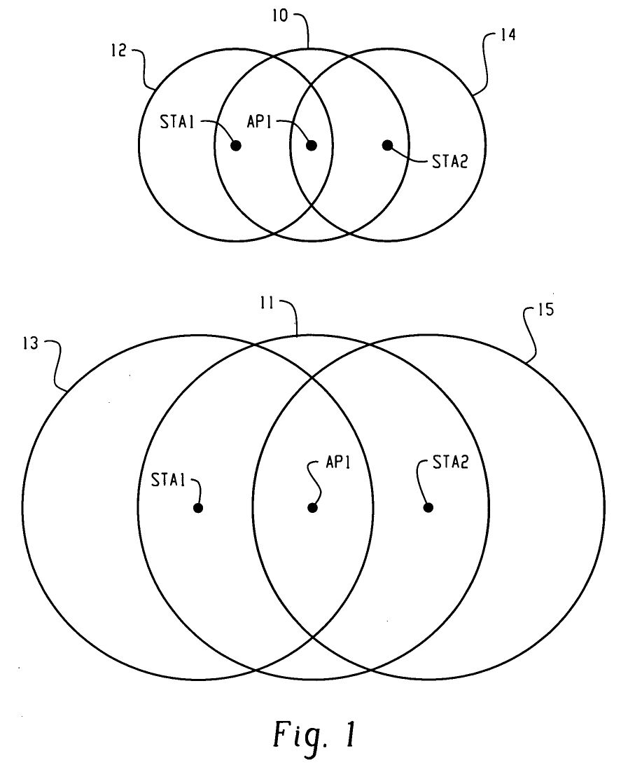

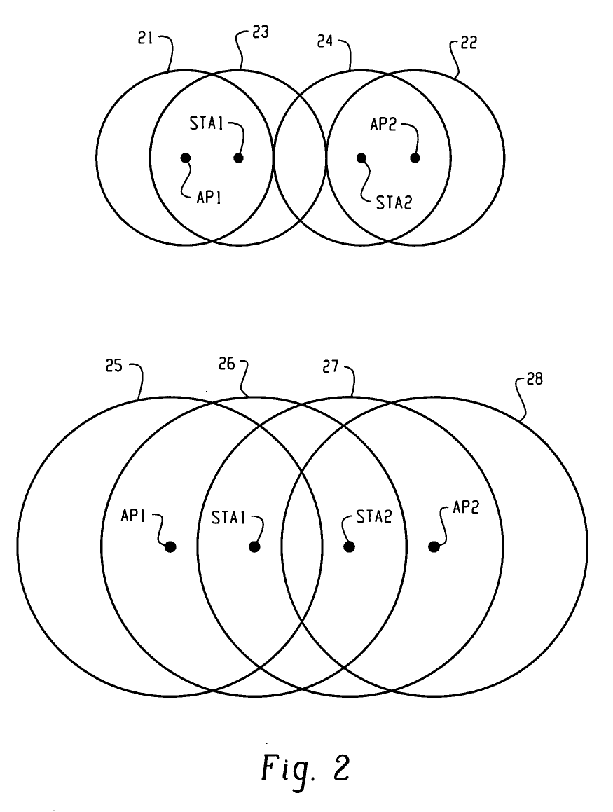

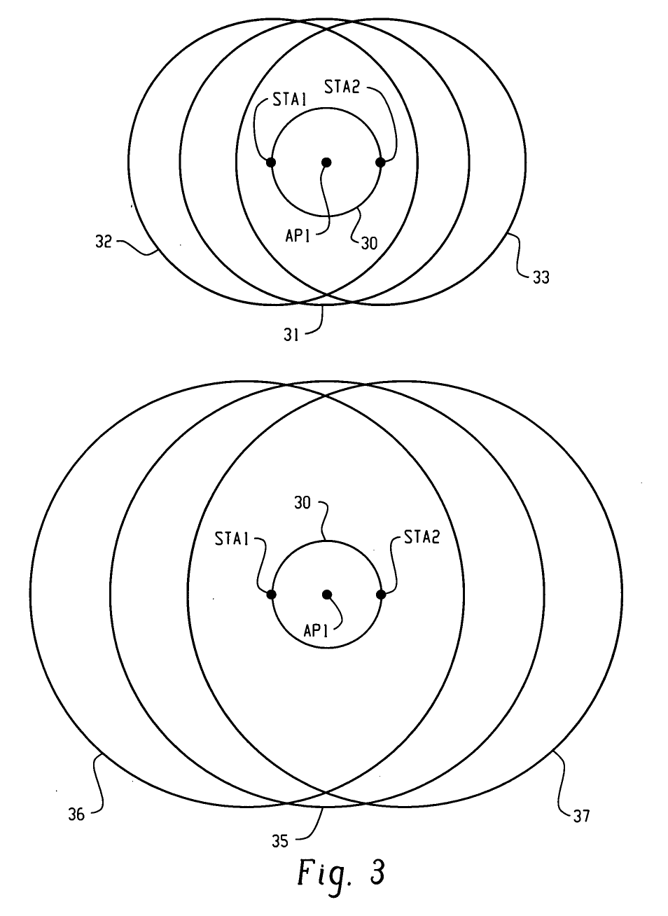

### DETAILED DESCRIPTION OF INVENTION

Throughout this description, the preferred embodiment and examples shown should be considered as exemplars, rather than limitations, of the present invention. Described herein is a method to adjust either the receiver communication sensitivity threshold (e.g., the Start Of Packet, SOP) and/or the receiver detection sensitivity threshold (e.g. the Clear Channel Assessment, CCA) in wireless stations operating in High Density wireless networks in order to achieve a desired range(s). One or both of these receiver sensitivities may be adjusted, together or separately (independently), in order to improve the intra-cell and inter-cell network efficiency. By improving the efficiency of the network, an available network capacity gain may be realized. The present invention includes apparatuses configured to implement a method and/or technique described herein.

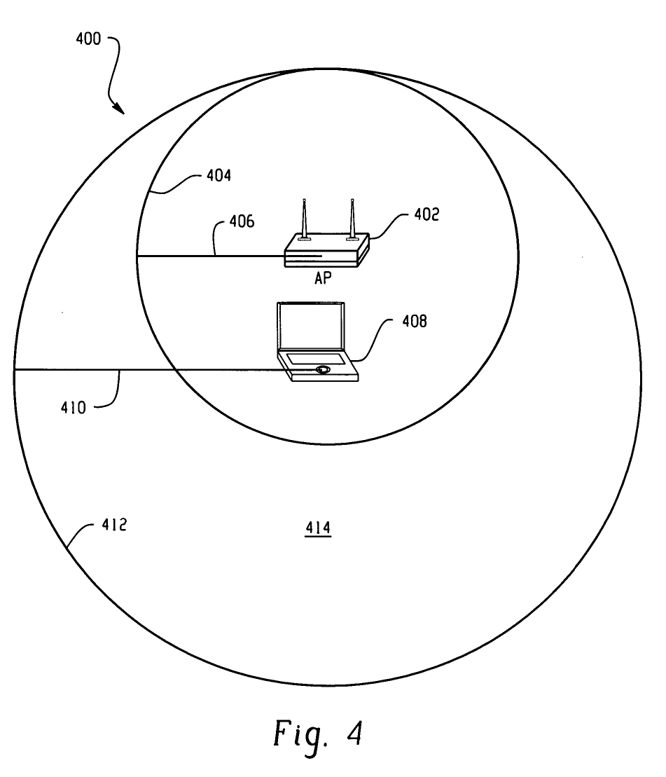

Referring now to FIG. 4, there is disclosed a system 400 implementing a technique for setting the detection sensitivity threshold of STA's operating in AP cells statistically to abate hidden nodes. AP 402 has a detection sensitivity threshold setting that corresponds to a conceptual AP 402 detection radius (e.g., AP 402 coverage plan) illustrated by circle 404 and a radius 406. STA 408 is associated to AP 402 and within detection cell (cell 404). The detection sensitivity threshold of STA 408 is initially adjusted equal to the detection sensitivity threshold setting of the AP 402 (e.g., default condition upon association to AP 402).

There are several methods available to STA 408 for determining the detection sensitivity threshold setting of AP 402. In one example, AP 402 and STA 408 use detection sensitivity threshold settings that are fixed upon association. In another example, AP 402 sends STA 408 the detection sensitivity threshold setting directly during the STA association period or during a subsequent STA management period. Further, the detection sensitivity setting sent from AP to STA can be absolute value or a relative value to be compared with another STA value, especially the communication sensitivity threshold setting (e.g., an offset value setting).

Once STA 408 has successfully associated with AP 402 and adjusted to the default detection sensitivity setting for cell 404 and radius 406, the STA 408 detection sensitivity setting may be further adjusted to cell 412 and radius 410 (e.g., increasing cell 404 to cell 412 increases the detection sensitivity radius 2 times) This procedure will mitigate occurrences of hidden nodes by extending the STA detection range (e.g., cell 412) to include the entirety of the AP detection range (e.g., cell 404).

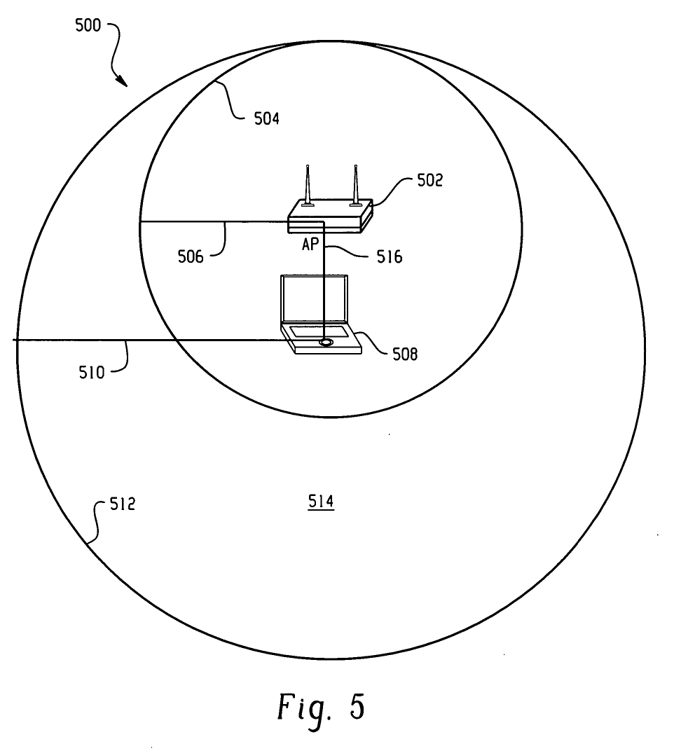

Referring now to FIG. 5, there is disclosed a system 500 implementing a technique for setting the detection sensitivity threshold of STA's operating in AP cells dynamically to abate hidden nodes (statistical adjustment values changing with time). AP 502 has a detection sensitivity threshold setting that corresponds to a conceptual AP 502 detection radius (e.g., AP 502 cell coverage plan) illustrated by circle 504 and radius 506. STA 508 is associated to AP 502 and within detection cell (cell 504). The detection sensitivity threshold of STA 508 is initially adjusted equal to the detection sensitivity threshold setting of AP 502 (e.g., default condition upon association to AP 502).

There are several methods available to STA 508 for determining the detection sensitivity threshold setting of AP 502. In one example, AP 502 and STA 508 use detection sensitivity threshold settings that are fixed upon association. In another example, AP 502 sends STA 508 the detection sensitivity threshold setting directly during the STA association period or during a subsequent STA management period. Further, the detection sensitivity setting sent from AP to STA can be absolute value or a relative value to be compared with another STA value, especially the communication sensitivity threshold setting (e.g., an offset value setting).

Once STA 508 has successfully associated with AP 502 and adjusted to the default detection sensitivity setting for cell 504 and radius 506, the STA 508 detection sensitivity setting may be further adjusted up to cell 512 and radius 510 (e.g., increasing cell 504 to cell 512 increases the detection sensitivity radius 2 times).

There are several methods available to STA 508 for dynamically (adjustment time intervals undefined) determining the detection sensitivity threshold increase (setting) to use when associated to AP 502. In each method, the STA 508 determines the detection sensitivity threshold increase in proportion to the approximate separation from STA 508 to AP 502. In one example, the separation may be derived from STA 508 and AP 502 received signal strength measurements averaged over a particular integration time period. In another example, the separation may be derived from STA 508 and infrastructure (AP's) RSSI measurements used to determine location (e.g., triangulation). In still another example, the separation may be derived from infrastructure (AP's) and/or stations (STA's) based on time difference of arrival (TDOA) measurements. Generally, the adjustment increase to the STA 508 default detection sensitivity is proportionate to the estimated physical separation increase (default setting referenced to the lowest reasonable separation). This procedure will mitigate occurrences of hidden nodes by extending the STA detection range (e.g., cell 512 max.) to include the entirety of the AP detection range (e.g., cell 504 max.).

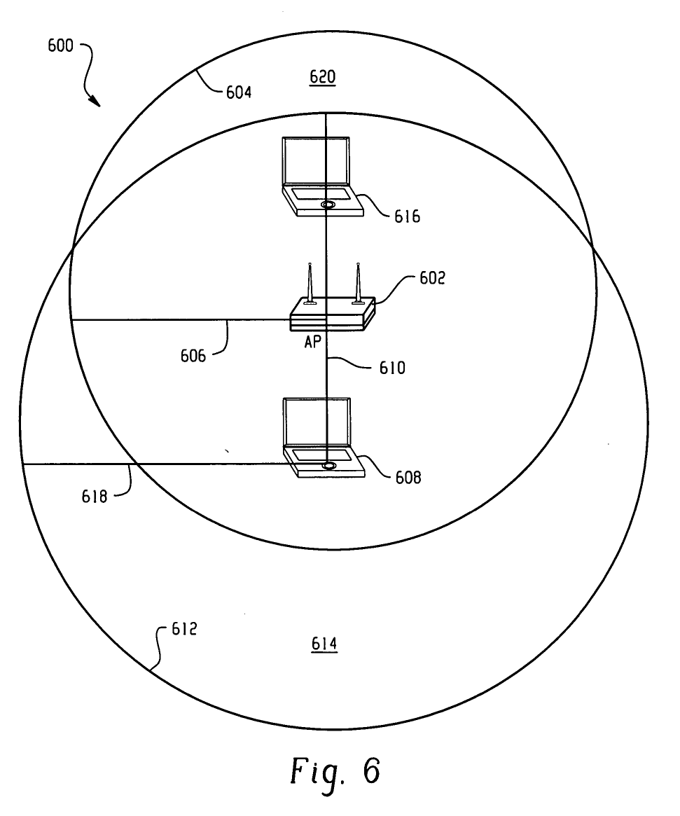

Referring now to FIG. 6, there is illustrated a system 600 that dynamically adjusts the size of a detection cell 612. In this system 600, the detection cell 612 size is only large enough to avoid collisions with other wireless stations (e.g., wireless station 616) inside cell 604 (hidden node mitigation) but also remains small enough in order to optimize the detection with other co-channel cells (e.g. CCA range), such as in region 614. This results in a lower chance of detection with other co-channel cells (not shown) but also maintains protection for nearby co-channel nodes and hidden node mitigation. For example, access point 602 has an associated cell area 604 with a cell radius 606 Wireless station 616 is inside cell 604, preferably it is the wireless station farthest away from access point 602. Wireless station 608 determines the physical separation 610 between itself and wireless station 616. Based on physical separation 610, wireless station 608 then determines a length for detection cell radius 618 resulting in detection cell 612. Wireless station 608 uses either physical separation between it and wireless station 616 or access point 602, whichever is longer to ensure that both wireless station 616 and access point 602 are within its detection cell. As stated herein supra, wireless station 608 can use any technique suitable for determining the physical separation between itself and access point 602 and/or wireless station 616. Furthermore, because access point 602 can determine the location of all wireless stations within range of AP cell 604, it is possible that access point 602 can periodically send out a message disclosing the location of all wireless stations within cell 604, enabling wireless stations to calculate the location of the farthest wireless station and set detection cell radius 618 accordingly. Depending on the location of the farthest wireless station (or the lack of another wireless station in the cell) it is possible for detection cell radius 618 to be even less than cell radius 606.

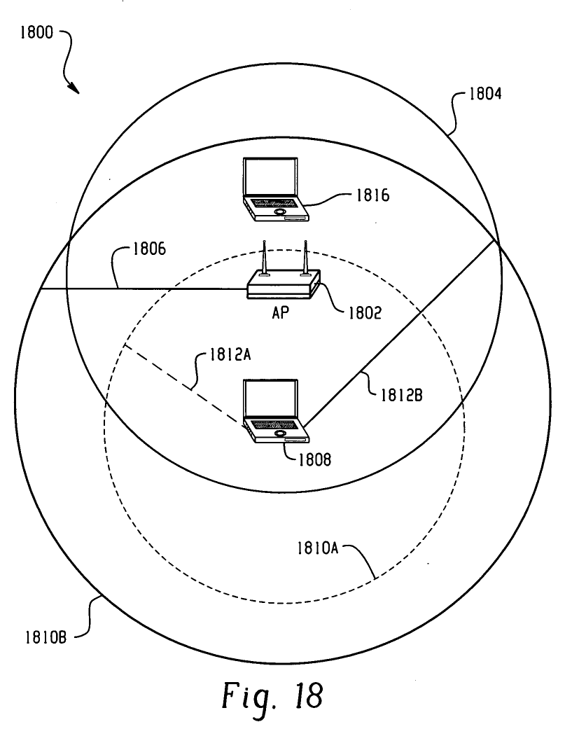

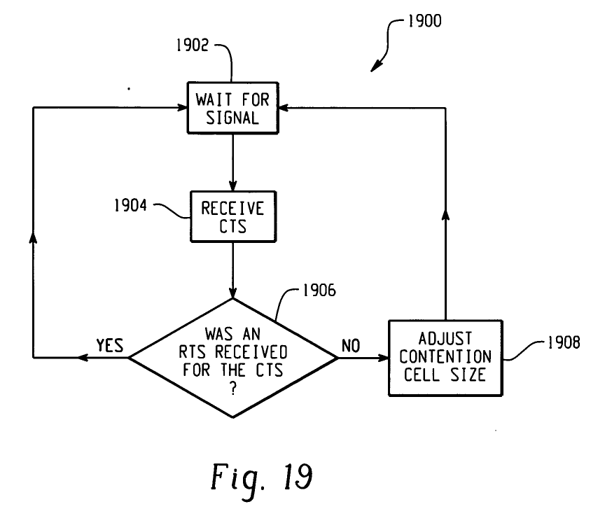

As can been observed in FIG. 6, there is a region 620 within cell 604 that is outside of detection cell 608, unlike the other systems described herein supra, which cover the entire cell 604. Because of region 616, wireless station 608 may need to regularly check where the farthest wireless station is located and adjust detection cell radius 618, and thus detection cell 612 accordingly. One technique to determine insufficient detection cell includes observation of clear-to-send (CTS) messages without reason sent by access point 602 or another nearby co-channel AP, see for example the description herein infra for FIGS. 18 and 19.

Referring to FIG. 18, there is illustrated a system 1800 for iteratively and dynamically setting the size of the detection cell 1810. In this example, access point 1802 has associated with it a detection (communication) cell 1804 with a corresponding detection (communication) cell radius 1806. Initially, wireless station 1808 has a detection cell 1810A with a detection cell radius 1812A. As wireless station 1808 detects another wireless station 1816 that is outside its detection cell 1810A, but within cell 1804, wireless station 1808 increases the detection sensitivity threshold and thus the detection cell to 1810B with a corresponding detection cell radius 1812B.

There are several techniques that wireless station 1808 can use for determining when to lengthen or shorten the detection cell radius 1812, and consequently detection cell 1810. For example, while wireless station 1808 can have set the detection sensitivity threshold, detection cell radius 1812A, it receives a Clear-To-Send (CTS) message from access point 1802. If wireless station 1808 determines that it did not receive the preceding Request-To-Send (RTS) message, it may assume that a wireless station exists outside its detection cell 1810, and in response, adjust the detection sensitivity threshold, cell radius 1812 (e.g., from 1812A to 1812B) until the size of detection cell 1810 (which expands from 181 OA to 1812B) includes wireless station 1816. Instead of adjusting the size of detection cell radius 1812 each time a CTS is sent where wireless station 1808 did not receive an RTS, it is also possible to adjust detection cell radius 1812 by waiting until a predetermined number of CTS messages are received within a predetermined time period. The receiver threshold adjustments may be continuously variable or in discrete steps. For example, cell radius 1812 can be smoothly increased (or decreased) ten percent or stepped any desired amount or iteration. Moreover, if wireless station 1808 becomes aware wireless station 1816 has disassociated from the cell, it can reduce the size of detection cell radius 1812, for example from 1812B to 1812A.

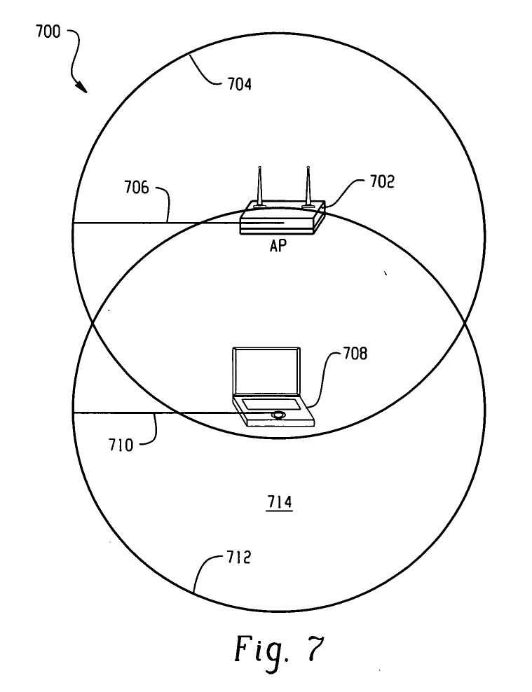

FIG. 7 is a diagram of a system 700 illustrating a technique for adjusting the detection cell statically to abate the exposed node problem. The exposed node problem occurs when a wireless station is associated to a given access point but listens to other devices operating outside that cell on the same RF frequency. As an example how the exposed node problem can affect a wireless network, if the access point transmits a packet to the wireless station, the packet could be missed because the wireless station is listening to a signal from another wireless station (or AP) from another cell, and misses the signal packet header coming from its own AP cell. The system 700 adjusts the detection sensitivity threshold statically to abate the exposed node problem. If the signal detection cell is to remain static, then the detection sensitivity threshold should be set so that the wireless station can communicate with the access point anywhere within the AP cell. By setting the detection sensitivity threshold approximately equal or a given offset (dB) from the communications sensitivity threshold, the exposed node problem is minimized by reducing (optimizing) the range that a wireless station can detect packets arriving from other same frequency neighboring cells. For example, in FIG. 7, access point 702 has a cell 704 defined by a cell radius 706. Wireless station 708 determines either the size of cell 704 and/or cell radius 706, and sets the detection sensitivity threshold corresponding to the cell range radius 710 to be equal to cell radius 706. This results in detection sensitivity range 712 that is substantially equal in size to cell size 704. However, even with a reduced detection sensitivity range 712, there will still be a region 714 outside of cell 704 that wireless station 708 will still be responsive.

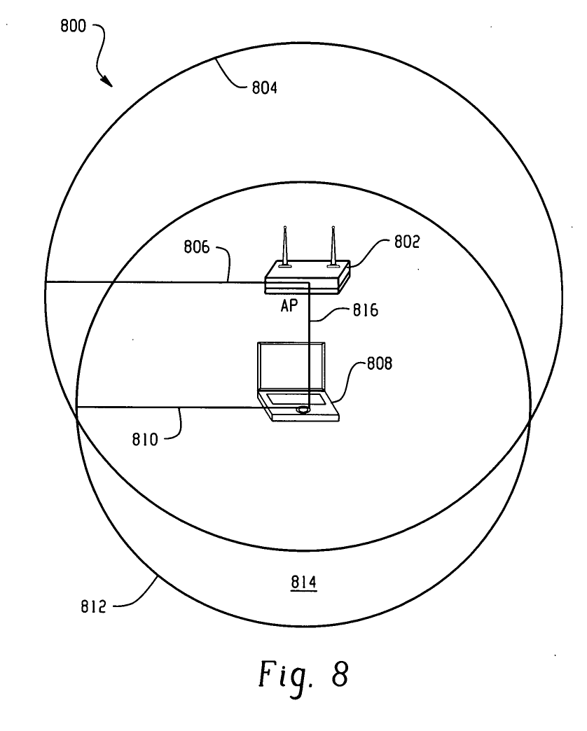

FIG. 8 is a diagram illustrating a system 800 for adjusting the detection range 812 dynamically to abate the exposed node problem. If the detection range 812 is set dynamically, it can expand or compress in order to set an optimum access point 802 detection range. The larger the station detection sensitivity cell 812 margin is, the more likely it may detect wireless stations operating in other co-channel AP cells and increase the probability of creating an exposed node problem. The exposed node problem may be avoided by reducing the detection cell coverage area that a wireless station can detect co-channel signals.

For example, in FIG. 8 there is illustrated an access point 802 for a cell 804 with a cell radius 806. Wireless station 808 determines the physical separation 816 between wireless station 808 and access point 802. As stated herein supra, any suitable technique can be used for determining physical separation 816. Wireless station 808 then sets detection cell radius 810 to be substantially equal to the physical separation 816 between wireless station 808 and access point 802. As can be observed in FIG. 8, only a small area 814 exists outside of cell 804, thereby reducing the chances of an exposed node interfering with wireless station 808.

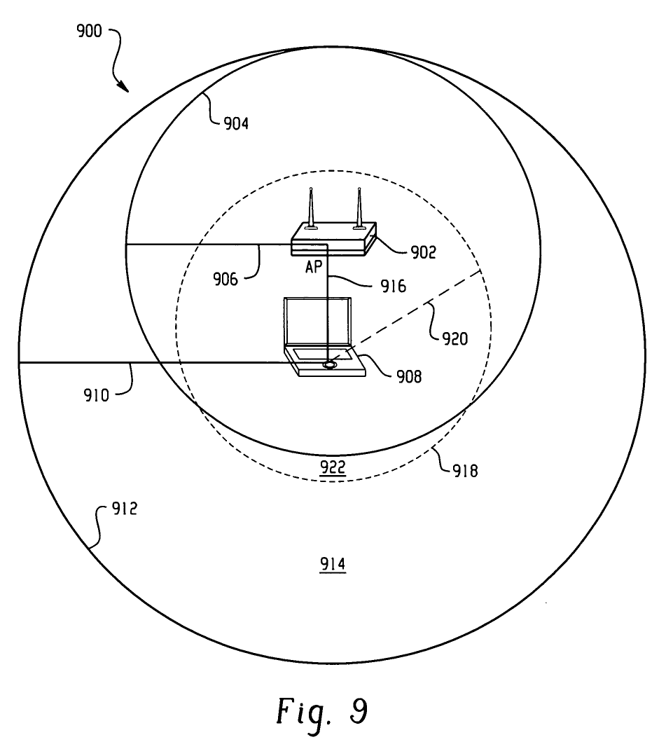

Although it is possible that the detection cell and communication cell can be set to the same size using any of the techniques as illustrated in FIGS. 4-8, or in FIGS. 15-17 which will be described herein infra, FIG. 9 illustrates an example of a system 900 wherein the detection cell and communications range are set independent of each other. In the example illustrated in FIG. 9, an access point 902 having communications cell 904 having a communications cell radius 906. Wireless station 908 is within communications cell 904. Wireless station 908 determines a physical separation 916 between itself and access point 902. Based on physical separation 916, wireless station 908 sets a detection sensitivity threshold to obtain a detection cell radius 910 resulting in a detection cell 912 which encompasses all of cell 904. Note that this method is not the only suitable method as any other static or dynamic techniques described herein are suitable for setting the size of detection cell 912. Region 914 illustrates the amount of detection cell 912 that exists outside of communications cell 904.

In addition to setting the size of detection cell 912, wireless station 908 also uses physical separation 916 to set the size of communication cell 918. In this example, wireless station 908 selects a communications sensitivity cell radius 920 that is substantially equal to physical separation 916. Region 922 illustrates the amount of communication cell 918 that exists outside of cell 904.

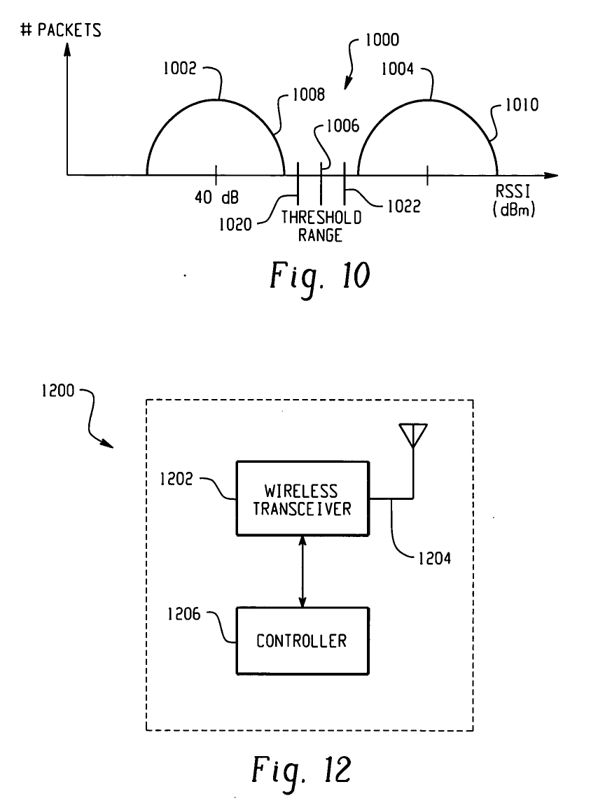

FIG. 10 illustrates a histogram 1000 for determining a threshold setting for the detection cell and/or the communication cell. As noted herein supra, the histographic threshold may be statistically set between distributions or the CCA deterministically set at a given offset position from the SOP set point. Referring to FIG. 11, with continued reference to FIG. 10, there is illustrated an exemplary system 1100 for the purposes of explaining histogram 1000.

System 1100 illustrates access points AP1, AP4, AP6, AP8 and AP11 corresponding to cells 1104, 1110, 1114, 1120 and 1126 respectively as operating on the same channel. As wireless stations 1128, 1130, 1116, 1120 and 1132 are i operating in one of cells 1104, 1110, 1114, 1120 and 1126 respectively, they are also operating on the same channel. AP2, AP3, AP5, AP7, AP9, AP10 corresponding to cells 1106, 1108, 1112, 1118, 1122 and 1124 respectively are operating on different channels.

Using wireless station 1116 as an exemplary wireless station for generating a histogram 1000 as illustrated in FIG. 10, signals from AP6 and any other wireless stations inside of 1114 (not shown) tend to form a curve 1008, having a peak 1002 in the histogram. As shown in FIG. 10, the # of packets are plotted against their corresponding signal strength (RSSI), however, this is illustrative only as other parameters may be employed for generating histogram 1000. For example, channel utilization may be observed either directly (packets/time) or indirectly (AP sends utilization of cell in management message). In addition RSSI measurements may be compared in ratio (desired (aggregate)/undesired (aggregate) to form SIR over aggregate period of time can be used instead of number of packets, and energy density can be used in place of RSSI. Packets received from farther away cells, e.g., cells 1104, 1110, 1120, 1126 would have a lower RSSI or energy density than packets received within cell 1114, and form a second curve 1010 with a second peak 1004. The first peak 1002 commonly referred to as the near peak and the second peak 1004 commonly referred to as the far peak In a preferred embodiment, wireless station 1116 would set the communications threshold (Tc) 1020 less than or equal to the detection threshold (Tc) 1022. In another embodiment, Tc and Td can be set equal; threshold setting 1006 is an example of setting the threshold levels Tc and Td equal. Preferably, the threshold level 1006 is set outside (lower) of curve 1008 and outside (higher) of curve 1010. Using either of these techniques enables wireless station 1116 to hold off or receive only signals sent from within cell 1114 and ignore all other signals on the same channel in other cells.

It should be noted that additional histographic curves may be formed by additional cells farther away than cells 1104, 1110, 1120 and 1126 (not shown). However, these curves will have less in signal strength and/or energy than curve 1010 and can be ignored.

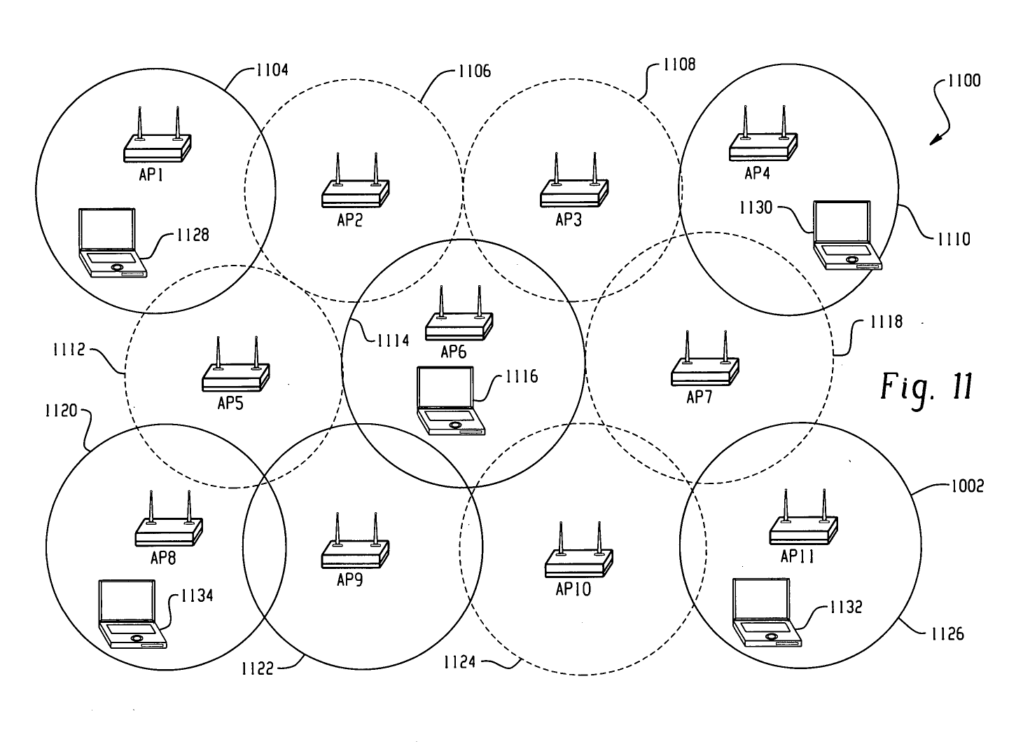

FIG. 12 is a block diagram of a wireless station 1200. Wireless station 1200 comprises a wireless transceiver 1202 coupled to an antenna 1204 and a controller 1206. Wireless transceiver 1202 comprises circuitry for receiving a signal (not shown), and modulating and/or converting the signal to be suitable to be transmitted wirelessly by antenna 1204. Controller 1206 comprises logic for controlling the operation of wireless transceiver 1206. In accordance with an aspect of the present invention, controller 1206 comprises logic for setting the detection sensitivity threshold to obtain a detection cell and a communication sensitivity threshold to obtain a communication cell using methods described herein.

“Logic”, as used herein, includes but is not limited to hardware, firmware, software and/or combinations of each to perform a function(s) or an action(s), and/or to cause a function or action from another component. For example, based on a desired application or need, logic may include a software controlled microprocessor, discrete logic such as an application specific integrated circuit (ASIC), a programmable/programmed logic device, memory device containing instructions, or the like, or combinational logic embodied in hardware. Logic may also be fully embodied as software.

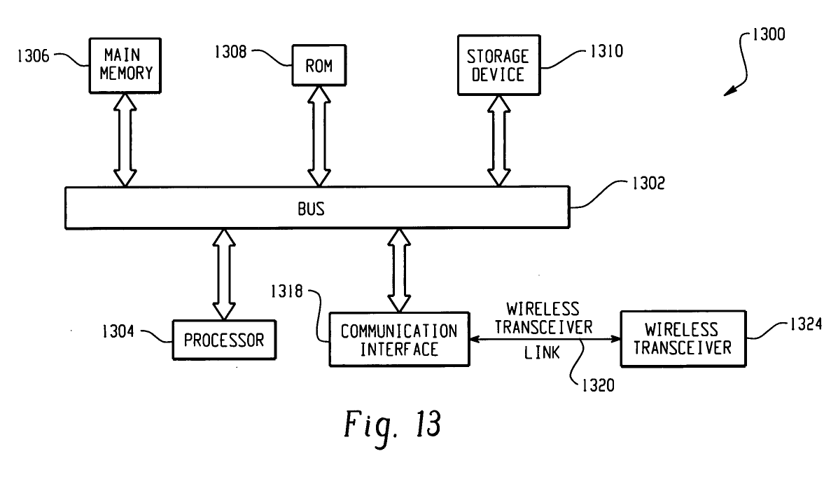

FIG. 13 is a block diagram that illustrates a computer system 1300 upon which an embodiment of the invention may be implemented. For example, controller 1206 (FIG. 12) can be embodied in computer system 1300. Computer system 1300 includes a bus 1302 or other communication mechanism for communicating information and a processor 1304 coupled with bus 1302 for processing information. Computer system 1300 also includes a main memory 1306, such as random access memory (RAM) or other dynamic storage device coupled to bus 1302 for storing information and instructions to be executed by processor 1304. Main memory 1306 also may be used for storing temporary variables or other intermediate information during execution of instructions to be executed by processor 1304. Computer system 1300 further includes a read only memory (ROM) 1308 or other static storage device coupled to bus 1302 for storing static information and instructions for processor 1304. A storage device 1310, such as a magnetic disk or optical disk, is provided and coupled to bus 1302 for storing information and instructions.

The invention is related to the use of computer system 1300 for adjusting one or more of detection sensitivity threshold to obtain a detection cell and a communication sensitivity threshold to obtain a communication cell of wireless transceiver 1324. According to one embodiment of the invention, adjusting one or more of detection cell and communication cell is provided by computer system 1300 in response to processor 1304 executing one or more sequences of one or more instructions contained in main memory 1306. Such instructions may be read into main memory 1306 from another computer-readable medium, such as storage device 1310. Execution of the sequence of instructions contained in main memory 1306 causes processor 1304 to perform the process steps described herein. One or more processors in a multi-processing arrangement may also be employed to execute the sequences of instructions contained in main memory 1306. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 1304 for execution. Such a medium may take many forms, including but not limited to non-volatile media, volatile media, and transmission media. Non-volatile media include for example optical or magnetic disks, such as storage device 1310. Volatile media include dynamic memory such as main memory 1306. Transmission media include coaxial cables, copper wire and fiber optics, including the wires that comprise bus 1302. Transmission media can also take the form of acoustic or light waves such as those generated during radio frequency (RF) and infrared (IR) data communications. Common forms of computer-readable media include for example floppy disk, a flexible disk, hard disk, magnetic cards, paper tape, any other physical medium with patterns of holes, a RAM, a PROM, an EPROM, a FLASHPROM, any other memory chip or cartridge, a carrier wave as described hereinafter, or any other medium from which a computer can read.

Computer system 1300 also includes a communication interface 1318 coupled to bus 1302. Communication interface 1318 provides a two-way data communication coupling to a link 1320 that is connected to a wireless transceiver 1324. Computer system 1300 can send messages and receive data, through link 1320, and communication interface 1318, enabling it to control the operation of wireless transceiver 1324.

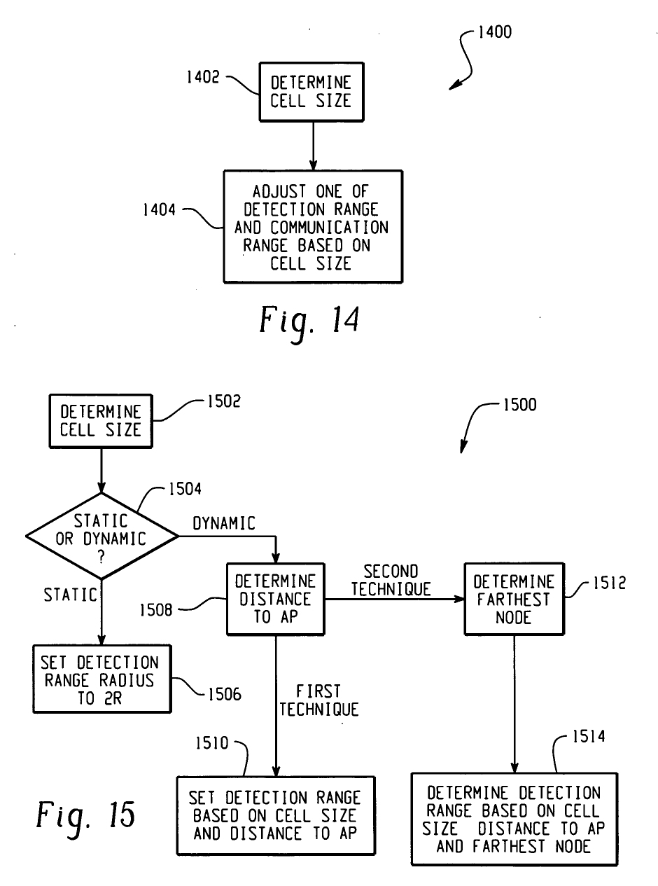

In view of the foregoing structural and functional features described above, methodologies in accordance with various aspects of the present invention will be better appreciated with reference to FIGS. 14-17 and 19. While, for purposes of simplicity of explanation, the methodologies of FIGS. 14-17 and 19 are shown and described as executing serially, it is to be understood and appreciated that the present invention is not limited by the illustrated order, as some aspects could, in accordance with the present invention, occur in different orders and/or concurrently with other aspects from that shown and described herein. Moreover, not all illustrated features may be required to implement a methodology in accordance with an aspect the present invention. Embodiments of the present invention are suitably adapted to implement the methodology in hardware, software, or a combination thereof.

FIG. 14 is a block diagram of a method 1400 for setting detection cell and/or communication cell range. At 1402, the wireless station determines the detection and communication cells for its associated AP cell. As stated previously herein supra, any suitable technique for determining physical separation between the wireless station and its associated access point is acceptable. At 1404, the wireless station adjusts either its detection cell or its communication cell, or both, based on the physical cell requirements of its associated AP cell. For an 802.11 compliant wireless transceiver, the detection cell can be set by adjusting the clear channel assessment (CCA) threshold, and the receiver communication cell can be set by adjusting the start of packet (SOP).

Both the detection cell and the communication cell can be set equal to each other or the detection cell and communication cell can be independently set to different sizes. Preferably, the detection cell is set large enough to abate the hidden node problem but small enough to prevent excessive transmission hold-offs for the wireless stations outside its associated AP cell. Additionally, preferably the receiver detection cell is set small enough to abate the exposed node problem that result in excessive receiver capture from signal emanating outside the AP cell. Any of the methodologies described herein, including those described in FIGS. 15-17 and 19, alone or in combination can be used for adjusting the detection cell and/or communication cells. The communications cell range is normally set to provide adequate link communication between AP and STA's.

FIG. 15 is a block diagram of a method 1500 for setting detection cell. At 1502 the wireless station determines the detection cell and/or a detection cell radius for its associated AP cell. As stated previously herein supra, any suitable technique for determining physical separation between the wireless station and its associated access point is acceptable. At 1504 it is determined whether a static technique or a dynamic technique will be used for setting the detection cell.

If at 1504 it is determined that a static detection cell is set (STATIC), then at 1506 the detection cell is set to two times the cell radius. An example of the technique used at 1506 is given in FIG. 4 described herein supra. This setting will eliminate the worse case hidden node scenarios by ensuring that the detection sensitivity cell always encompasses the entirety of associated AP cell.

If at 1504 it is determined that a dynamic detection sell size is to be used (DYNAMIC), then at 1508 the wireless station determines the physical separation to its associated access point (AP). By using a dynamic detection cell, the detection cell only needs to be large enough to avoid collisions with other wireless station operating inside the AP cell (hidden node mitigation) but also allows the detection cell to remain small enough to optimize the detection with other co-channel cells outside cell. Consequently, there is a detection efficiency gain with respect to local co-channel wireless stations while providing hidden node mitigation within AP cell.

At 1510, in accord with a first technique for dynamically setting detection cell, the detection cell is set based on the wireless station detection cell size and the physical separation to the access point. As the wireless station moves towards its access point, the size of the detection cell diminishes. Similarly, as the wireless station moves away from the access point, the detection cell increases. For example, if wireless station is next to the access point, the radius of the detection cell is approximately equal to the radius of the AP cell. In the worse case scenario, when wireless station is at the edge of the AP cell and the radius of the detection cell may be approximately twice the AP cell radius to ensure the entire AP cell is within the wireless station detection cell. Thus, the detection cell radius varies from a minimum value of approximately R (where R is the AP detection cell radius) to a maximum value of 2R. The wireless station can use any technique suitable for determining its physical separation from the associated access point, including but not limited to RSSI and/or TDOA. An example of a system employing the technique of 1510 is illustrated in FIG. 5.

Alternatively, at 1512, in accordance with a second technique, the wireless station determines the location of the wireless station node that is farthest away from the access point. At 1514 the wireless station determines the detection cell based on AP cell size, the wireless station's physical separation to the access point, and the physical separation of the farthest node from the access point. Using the technique of 1514, the detection cell is only large enough to avoid collisions with other wireless stations inside AP cell 604 (hidden node mitigation) but also remains small enough in order to optimize the detection with other co-channel cells. This results in a lower chance of detection with other co-channel cells but also maintains hidden node mitigation.

The wireless station uses either physical separation between itself and the wireless station farthest away from the access point, or the physical separation between itself and the access point, whichever is longer to ensure that both the wireless station farthest away from the access point and the access point are within its detection cell. As stated herein, wireless station can use any technique suitable for determining the physical separation between itself and the access point and/or the wireless station farthest away from the access point. Depending on the location of the farthest wireless station (or the lack of another wireless station in the cell) it is possible for detection cell radius to be even less than the AP cell radius. An example of a system employing the technique of 1514 is illustrated in FIG. 6.

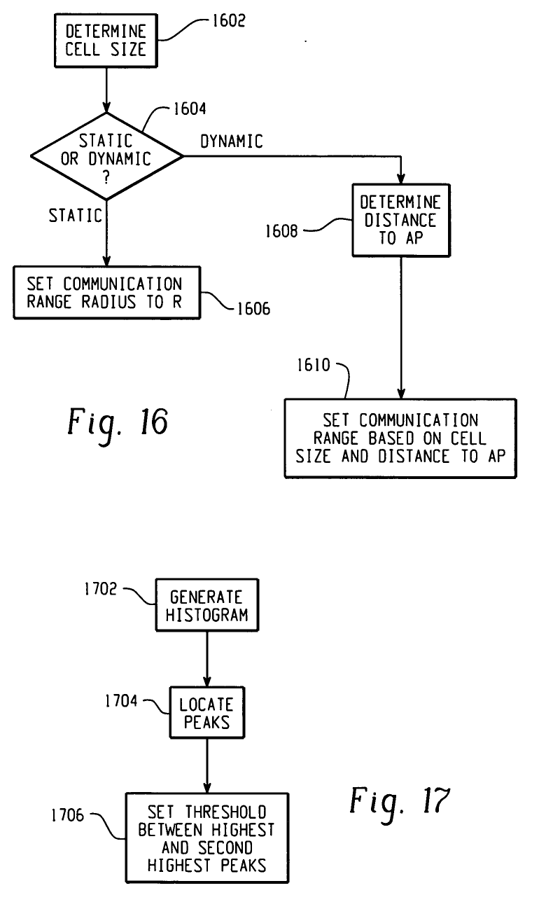

FIG. 16 illustrates a method 1600 for setting detection cell to abate the exposed node problem. The exposed node problem occurs when a wireless station is associated to a given access point but can listen to other devices operating outside that desired physical AP cell on the same frequency. As an example of the exposed node problem, if the access point transmits a packet to the wireless station, the packet could be missed because the wireless station is listening to a signal from another wireless station (or AP) from another cell, and doesn't detect the signal from its own AP cell.

At 1602 the wireless station determines either the AP cell range or the cell radius or both. At 1604, it is determined whether the receiver sensitivity thresholds will be set statically or dynamically.

If the communication sensitivity threshold is to remain static, then the communication sensitivity threshold should be set so that the wireless station can communicate with the access point throughout the entire cell. Therefore if at 1604 it is determined that the communication cell is set statically (STATIC), then at 1606 the radius of the communication cell is set to the same size as the cell radius (R). By setting the communication radius equal to the cell radius, the exposed node problem is reduced by shrinking the amount of area that a wireless station can receive, reducing the chance it will receive other signals from other co-channels in neighboring basic service sets. An example of a system employing the technique of 1606 is illustrated in FIG. 7.

Alternatively, the communication cell can be adjusted dynamically to abate the exposed node problem. If the communication cell is set dynamically, it can expand or shrink in order to keep the wireless station's associated access point in its range and maintain a link with the access point. The larger the client communication cell is, the more likely it may hear signals from another co-channel and create an exposed node problem. The exposed node problem is avoided by shrinking the amount of area that a client can receive “sense,” reducing the change that co-channel signals will interfere.

If at 1604 it is determined that the communication cell will be dynamically set (DYNAMIC), at 1608 the wireless station determines the physical separation between itself and its associated access point. As has been stated herein, any suitable technique can be used for determining physical separation, including but not limited to RSSI and/or TDOA. At 1610, the wireless station sets the communication cell radius to be substantially equal to the physical separation between wireless station and the access point. An example of a system employing the technique of 1610 is illustrated in FIG. 8.

FIG. 17 is a block diagram of a method 1700 using a histogram for setting detection cell and/or communication cell. An example of a histogram is given in FIG. 10. At 1702 a histogram is generated. The histogram would typically plot a measure of packet occurrences, or throughput rate, against RSSI or energy density. For example, FIG. 10 shows the number of packets plotted against the packet's RSSI. As was explained herein with reference to FIG. 10, histographic curves are usually formed, with one curve for packets that initiated within the cell forming one curve, and another curve formed by packets that initiated outside the cell. The curves ordinarily have peaks. At 1704, the peaks are located. The first peak being the peak for the curve with the highest RSSI and/or energy density, and the second peak for the curve the next (second) highest RSSI and/or energy density. If the curves are relatively flat, then boundaries of the curves can be used for this method instead of the peaks. At 1705 the threshold, either the detection cell radius (or size) and/or the communication cell radius (or size) are set to between the first and second peaks. By between the first and second peaks is meant that the cell size (detection and/or communication) is set so that packets under the first curve, the curve with highest RSSI and/or energy density which is indicative of packets initiated within the cell are processed by the wireless station (either for holding off transmission and/or for receiving) and packets under the second, and any other curves with lower RSSI and/or energy density are ignored.

FIG. 19 is a block diagram of a method 1900 for iteratively adjusting the detection cell. At 1902, the wireless station waits for a signal. At 1904 the wireless signal receives a clear-to-send (CTS). For example, the CTS can be sent by the access point responsive to another station sending a request to send (RTS) after a collision. At 1906 the wireless determines whether it received a corresponding RTS for the CTS. If the wireless station received a corresponding RTS (YES), then the wireless station waits for the next signal at 1902. However, if the wireless station did not receive the corresponding RTS, at 1908 the detection cell is adjusted (expanded).

However, it should be appreciated that there are several techniques that wireless station can use for determining when to expand or reduce the size of detection cell radius and consequently the detection cell. For example, while a wireless station has its detection cell radius set at a first setting if it receives a CTS message as in 1904, but determines that it did not receive the preceding request-to send (RTS) signal at 1906, it can assume that a wireless station exists outside its detection cell, and increase the size of detection cell (or cell radius) iteratively or continuously until the size of detection cell includes wireless station that initiated the RTS. Furthermore, instead of adjusting the size of detection cell (or cell radius) each time a CTS is sent where wireless station did not receive an RTS, it is also possible may adjust detection cell (and/or radius) by waiting until a predetermined number of CTS messages are received within a predetermined time period. In addition, the size of each adjustment is also variable. For example, the detection cell radius can be increased (or decreased) ten percent or any other desired amount. Moreover, if wireless station does not notice any traffic from the wireless station causing the CTS after a predetermined time period, it can reduce the size of the detection cell (and/or radius). FIG. 18 provides an example of a system employing methodology 1900.

What has been described above includes exemplary implementations of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims interpreted in accordance with the breadth to which they are fairly, legally and equitably entitled.

What is claimed is:

1. A method for operating a wireless station, comprising:
setting one of the group consisting of a detection sensitivity threshold to achieve a detection range and a communication sensitivity threshold to achieve a communication range based on a physical cell size requirement and having a cell radius requirement.

2. A method according to claim 1, the setting further comprising setting the detection sensitivity threshold and the communication sensitivity threshold so that the detection range and the communication range are equivalent to each other.

3. A method according to claim 1, the setting further comprising independently setting the detection sensitivity threshold and the communication sensitivity threshold so that the detection range and the communication range are different.

4. A method according to claim 1, wherein the detection cell is set by adjusting a packet detection threshold or clear channel assessment threshold and the communication cell is set by adjusting a packet demodulation threshold or start of packet threshold.

5. A method according to claim 1, wherein a radius of the detection cell is set to twice the AP cell association radius.

6. A method according to claim 1, further comprising:
determining a physical separation between the wireless station and an associated access point; and
the receiver sensitivity threshold setting comprising setting the detection cell so that the detection cell covers the entire AP cell association area.

7. A method according to claim 6, wherein a radius of the detection cell is within a range of the cell radius and twice the cell radius, inclusive.

8. A method according to claim 1, further comprising:
determining a physical separation between the wireless station and an associated access point;
determining a physical separation between the associated access point and a second wireless station associated with the access point that is farthest from the access point; and
the setting comprising setting the detection cell with a radius so that the detection cell includes the second wireless station associated and the associated access point.

9. A method according to claim 1, the setting comprising setting the communication cell to be equal to the cell size.

10. A method according to claim 1, further comprising:
determining a physical separation between the wireless station and an associated access point; and
the setting comprising setting the communication sensitivity threshold so that the communication cell is just large enough to include the associated access point.

11. A method according to claim 10, the setting comprising setting the detection sensitivity threshold so that the detection cell includes the access point.

12. A method according to claim 11, further comprising:
determining a physical separation between the associated access point and a second wireless station associated with the access point that is farthest from the access point; and
the setting comprising setting the detection sensitivity threshold so that the detection cell includes the second wireless station associated and the associated access point.

13. A method according to claim 1, further comprising:
generating a histogram that includes a parameter of packets received plotted against the a parameter indicative of signal strength;
determining at least two peaks of the histogram, the first peak being a peak with a parameter indicative highest signal strength of the at least two peaks and the second peak being a peak with a parameter indicative of a second highest signal strength; and
the setting comprising setting one of the group consisting of the detection sensitivity threshold and the communication sensitivity threshold to a threshold level between the first peak and the second peak.

14. A method according to claim 1, further comprising:
receiving a clear to send signal sent by an access point associated with the wireless station for which a corresponding request to send signal was not received; and
adjusting the detection cell responsive to the receiving the clear to send signal.

15. A wireless station, comprising:
a wireless transceiver; and
a controller coupled to the wireless transceiver and operative to control the operation of the wireless transceiver;
wherein the controller is configured for setting one of the group consisting of a detection sensitivity threshold to obtain a detection cell and the a communication sensitivity threshold to obtain a communication cell based on a cell size having a cell radius.

16. A wireless station according to claim 15, wherein the controller is configured to setting a radius of the detection cell is set to twice the cell radius.

17. A wireless station according to claim 15, further comprising:
the controller operative to determining a physical separation between the wireless station and an associated access point; and
the controller responsive to the determining the physical separation to setting the detection sensitivity threshold so that the detection cell covers the entire cell size

18. A wireless station according to claim 15, further comprising:
the controller operative to determining a physical separation between the wireless station and an associated access point;
the controller operative to determining a physical separation between the associated access point and a second wireless station associated with the access point that is farthest from the access point; and
the controller responsive to determining the physical separation between the wireless station and the associated access point and determining the physical separation between the associated access point and the wireless station associated with the access point that is farthest away from the access point to setting the detection sensitivity threshold so that the detection cell includes the second wireless station and the associated access.

19. A wireless station according to claim 15, wherein the controller is configured to setting the communication sensitivity threshold to obtain a communication cell equal to the cell size.

20. A wireless station according to claim 15, further comprising:
the controller is operative to determining a physical separation between the wireless station and an associated access point; and
the controller is responsive to determining the physical separation between the wireless station and the associated access point to setting the communication sensitivity threshold to obtain a communication cell just large enough to include the associated access point.

21. A wireless station according to claim 15, further comprising:
the controller operative to determining a physical separation between the wireless station and an associated access point;
the controller responsive to determining the physical separation between the wireless station and the associated access point to setting the detection sensitivity threshold so that the detection cell includes the wireless station associated with the access point that is farthest from the access point; and
the controller responsive to determining the physical separation between the wireless station and the associated access point to setting the communication sensitivity threshold to obtain a communication cell just large enough to include the associated access point.

22. A wireless station according to claim 15, further comprising:
the controller operative to generating a histogram that includes a parameter of packets received plotted against the a parameter indicative of signal strength;
the controller responsive to generating the histogram to determining at least two peaks of the histogram, the first peak being a peak with a parameter indicative highest signal strength of the at least two peaks and the second peak being a peak with a parameter indicative of a second highest signal strength; and
the controller responsive to determining the at least two peaks to setting one of the group consisting of the detection sensitivity threshold and the communication sensitivity threshold-to a threshold level between the first peak and the second peak.

23. A wireless station, comprising:
means adapted for determining a cell radius; and
means adapted for setting one of the group consisting of the detection sensitivity threshold to obtain a detection cell and communication sensitivity threshold to obtain a communication cell based on a cell radius.

24. A wireless station according to claim 23, the means adapted for setting is configured to set the detection sensitivity threshold to obtain a radius of the detection cell to twice the cell radius.

25. A wireless station according to claim 23, further comprising:
means adapted for determining a physical separation between the wireless station and an associated access point; and
the means adapted for setting comprising means for setting the detection sensitivity threshold so that the detection cell covers the entire cell size

26. A wireless station according to claim 23, further comprising:
means adapted for determining a physical separation between the wireless station and a second wireless station within the cell radius that is farthest from the wireless station; and
the means adapted for setting comprising means for setting the detection sensitivity threshold so that the detection cell includes the second wireless station.

27. A wireless station according to claim 23, the setting means adapted for setting comprising means for setting the communication cell equal to the cell size.

28. A wireless station according to claim 23, further comprising:
means adapted for determining a physical separation between the wireless station and an associated access point; and
the means adapted for setting comprising means for setting the communication cell to be just large enough to include the associated access point.

29. A wireless station according to claim 28, the means adapted for setting further comprising means adapted for setting the detection cell based on the cell radius and the physical separation between the wireless station and the associated access point.

30. A wireless station according to claim 23, further comprising:
means adapted for generating a histogram that includes a parameter of packets received plotted against the a parameter indicative of signal strength;
means adapted for determining at least two peaks of the histogram, the first peak being a peak with a parameter indicative highest signal strength of the at least two peaks and the second peak being a peak with a parameter indicative of a second highest signal strength; and
the means adapted for setting comprising means adapted for setting one of the group consisting of the detection sensitivity threshold and the communication sensitivity threshold to a threshold level between the first peak and the second peak.
